(19) United States
(12) Patent Application Publication
(10) Pub. No.: US 2020/0338552 A1
(43) Pub. Date: Oct. 29, 2020

(54) Systems And Methods For Microfluidic Interfaces

(71) Applicants: Steven Scherr, Brookline, MA (US); Colin J. H. Brenan, Marblehead, MA (US); Michael J. Brenan, Marblehead, NJ (US); Marcel Reichen, Wadenswil (CH); Raphael Clement Li-Ming Doineau, Paris (FR)

(72) Inventors: Steven Scherr, Brookline, MA (US); Colin J. H. Brenan, Marblehead, MA (US); Michael J. Brenan, Marblehead, NJ (US); Marcel Reichen, Wadenswil (CH); Raphael Clement Li-Ming Doineau, Paris (FR)

(21) Appl. No.: 16/760,106

(22) PCT Filed: Oct. 24, 2018
(86) PCT No.: PCT/EP2018/079181

§ 371 Date: Apr. 29, 2020

(30) Foreign Application Priority Data
Nov. 1, 2017 (EP) PRO62580252

(51) Int. Cl. B01L 3/00; B01L 3/02

(52) U.S. Cl. CPC B01L 3/502715; B01L 3/502776; B01L 3/0293; B01L 2200/0647; B01L 2300/0832; B01L 2400/0487; B01L 2200/027

(57) ABSTRACT

The present invention is directed to a fluidic interface for delivering a fluid into a microfluidic device, the interface comprising a chamber comprising a first accepting/delivering fluid opening and a second accepting/delivering fluid opening, each opening being positioned opposite to the other, wherein the diameter of the first accepting/delivering fluid opening is smaller than the internal diameter of the chamber and a tubing system connecting the first accepting/delivering fluid opening to a pressure source capable of generating positive or negative pressure. The interface is characterized in that the second accepting/delivering fluid opening is designed to mechanically limit its insertion into a receptacle of a microfluidic device to ensure a predetermined gap (H) between the second accepting/delivering fluid opening and a lower side of the receptacle of a microfluidic device.

### FIELD

The present invention generally relates to the methods and systems for delivery of homogeneous fluids or heterogeneous fluids containing cells, reagents, microdrops and/or particles into and out of microfluidic devices.

### BACKGROUND

Introduction of homogeneous fluids or heterogeneous fluids containing cells, reagents, microdrops and particles into a microfluidic device and the collection of fluids, cells, reagents and particles output from a microfluidic device is important to implementing biochemical and cell assays in these devices. Typically, a microfluidic device needs to be fluidically connected to external macroscale reservoirs containing the different assay components and to a source providing the force to move fluids through the microfluidic channels of the device. The large difference in physical dimensions between the microscopic channels of the microfluidic device and the external macroscopic reservoirs and fluid driving sources motivates the need for fluidic interfaces that seamlessly interface the microdevice with external macroscopic systems.

Ideal specifications of the interface are several and enumerated as follows. First, the interface needs to have minimal to no dead volume wherein an excess amount of fluid is needed to fill and provide continuity in the fluidic connection between the microdevice and reservoirs. This is especially important if the fluid contains cells or other time or environmentally sensitive materials that could readily degrade or change if the fluid is entrained in a volume that does not interact with the microfluidic device. Further, this problem becomes particularly acute when the fluid contains a limited number of cells from a specimen or an expensive or otherwise valuable reagent. Entrapment of the cells or reagent in a volume that does not interact with the device wastes the cells and precious reagents and this wastage is costly both financially and scientifically. Second, the interface needs to minimize or prevent any damage to cells, particles or microdrops that pass through the interface to maximize the utilization of these materials in the device and the fidelity of any analytical measurement. Thirdly, the interface needs to prevent or limit sedimentation of cells, particles or microdrops from the carrier fluid. This would further limit the number of cells, particles or microdrops available for input to the microfluidic device and be available for analysis or interaction with other components in the device. A fourth consideration is the need for the fluidic interface to be simple to use by a human operator and reliable and robust in making and breaking the fluidic interface so the connection can be used multiple times without failure. Failure is defined as either leaking fluid, entraining air or blocking fluid flow between a macroscopic system and microdevice. The interface connection should be readily connected with standard external reservoirs, such as Eppendorf tubes, containing the fluids to be delivered into the microdevice and it should be readily connected to a diversity of pressure sources including syringe pumps and valves pressurized by an external pressure source such as a high pressure gas cylinder or a gas pressure generator such that the pressure at the microdevice inlet is higher than the pressure at the outlet. The magnitude of this pressure difference is such to move liquids through the microdevice at a prescribed rate so as to implement a defined set of fluidic operations. One example is described in Abate and Weitz (Biomicrofluidics 5, 014107, 2011) where a syringe pump is connected to the outlet of a microdevice and the inlet of the device is at ambient pressure. As the syringe pump plunger is withdrawn, the negative pressure at the device outlet drives fluid through the microdevice. A final aspect is that the wetted surfaces of the fluid interface need to be inert relative to the fluid and materials in the fluid in contact with the interface material. This is to prevent non-specific adsorption of reagents, microdrops or cells on the surface and change the stoichiometry of reactions involving these materials in the microfluidic device.

Present interface methods and devices do not exhibit the properties needed to be an effective interface and are therefore inadequate and suboptimal in solving the problem of interfacing a microfluidic device with the external world. Present devices and methods typically involve a small diameter tube, either flexible or rigid, mechanically connecting an external reservoir or external pressure source to the microfluidic device. The physical interface between the tube and microdevice can be a mechanical press fit where the tube is inserted directly into a close fitting receptacle in the microdevice. If the microdevice is fabricated from a flexible material like polydimethylsiloxane (PDMS) and if the tubing is made from an elastically stiffer material like polyethylene then the tubing can be directly inserted into a hole in the microdevice material to connect directly to a microchannel and where the microdevice material forms a leak-tight seal around the tubing. This interface design is suitable for fluidically transmitting a diversity of different materials in fluids of different viscosities and heterogeneity to include cells, reagents and microdroplets in a fluid but suffers from excessive dead volumes, wetted surface area, is difficult to implement by an operator and is not robust in reliably and repetitively connecting and disconnecting the fluidic seal.

A preferred embodiment would be to have an interface device and method that overcomes the limitations of current devices and methods to make it easier and straightforward to connect the microfluidic device to external reservoirs and fluid driving sources without introducing physical, chemical or biological bias in the fluid and materials input to the microdevice; without loss of material and is a simple interface design to repeatedly and reliably connect and disconnect the fluidic connection without degradation of the interface. Additionally, the preferred embodiment would be capable of introducing more than one sample into the microfluidic device; either introducing different samples in a serial or parallel manner.

### SUMMARY

The present invention generally relates to a fluidic interface design that overcomes the limitations of current designs and provides benefit through a consistent and reliable interface between a microfluidic device and external reservoirs and pressure sources. The subject matter of the present invention involves, in some cases, interrelated products, alternative solutions to a particular problem, and/or a plurality of different uses of one or more systems and/or articles.

In one aspect, the present invention is generally directed to a device. In one set of embodiments, the device includes providing a chamber with an opening accepting a tube with outside diameter smaller than the inside dimension of the chamber and a second opening positioned opposite the first opening (the exit orifice) designed to interface with a receptacle connected to a channel in a microfluidic device. The tubing is connected at one end to a pressure source capable of generating positive or negative pressure. The chamber could be conical in shape along its long axis with a flexible tubing physically connected to the large diameter opening and the opposite end with the small diameter opening connected to the receptacle in the microfluidic device. If the receptacle is a straight wall cylinder, the cone taper angle and thickness of the microfluidic device is such that when the conical chamber is inserted into the receptacle, the cone rests on the upper edge of the receptacle to position the exit orifice so that it does not touch the bottom of the microfluidic channel. Achieving this condition prevents the exit orifice from contacting the microfluidic channel bottom and blocking the flow of liquid from the reservoir into the microchannel. This gap must also be big enough to ensure the flow of cells, hydrogel beads and other particulates without either blocking the flow or imposing a shear force that could damage or break apart the particulates. In a second embodiment, there could be a shoulder on the cone to limit insertion depth to achieve the same result. Alternatively, the receptacle could be cone shaped with the same taper angle as the chamber and when the chamber is inserted into the receptacle, the exit orifice is positioned above the bottom of the microfluidic channel. Furthermore, having the exit orifice at an angle to the central axis of the chamber would further prevent blockage of the orifice by increasing the size of the exit orifice and having it at an angle to the plane defined by the microfluidic channel.

In another embodiment, multiple chambers can be connected to different receptacles of a microfluidic device to deliver different materials to different microfluidic channels in the device. This is important in the case where cells and reagents are input to a microfluidic device in order to perform an analysis of the cells input to the device.

In another embodiment, the chamber is open to ambient pressure and the outlet of the microdevice is connected to a negative pressure source. The pressure difference between the chamber and the microdevice moves the contents of the chamber into the microfluidic device. The flow rates of fluids and fluids with particulates from different chambers connected to the microdevice can be modified by introducing a restriction to the fluid flow by reducing the exit orifice diameter. In this way the flow of different fluids into the microdevice to ensure specific analytical objectives is achieved. Furthermore, the change in orifice diameter can be combined with changes in the microfluidic channel dimensions to further refine and improve on control of fluids and particulates through different channels in the microdevice.

In another embodiment, the hydraulic fluid level in the chamber is monitored by either optical, electrical or acoustic means to prevent the hydraulic fluid from entering the microdevice. One example would be monitoring for a change in optical absorption between the fluid that is dispensed and the hydraulic fluid containing an absorbing or fluorescent dye to determine the position of the fluid in the chamber. A similar monitoring device could be used to determine when the chamber is full during fluid aspiration.

In a second aspect, the present invention is generally directed to a method. The tubing and chamber are filled with an immiscible liquid, the hydraulic fluid, and the level of the liquid in the chamber is determined by the pressure difference between the exit orifice and the pressure source. The exit orifice is immersed in a container filled with a second liquid immiscible with the hydraulic fluid and there is a negative pressure applied then the movement of the hydraulic fluid away from the exit orifice will cause the liquid to move into the chamber. This process proceeds until a certain volume of liquid is transferred into the chamber, the chamber is removed from the liquid, inserted into the microfluidic receptacle and the chamber pressurized by the movement of hydraulic fluid to dispense from the chamber into the microfluidic channel. The pressure is decreased to reverse the hydraulic fluid flow to aspirate the sample into the chamber. A second embodiment is for the aspiration and dispensing of fluids containing particulates such as hydrogel beads or cells. In this case the hydraulic fluid may be miscible in the fluid carrying the particulates and pressure applied in an analogous manner to aspirate the fluid containing particulates and the pressure reversed to aspirate the particulates into the microfluidic channel.

### BRIEF DESCRIPTION OF THE DRAWINGS

Non-limiting embodiments of the present invention will be described in the figures.

FIG. 1A shows one preferred embodiment of the injection reservoir, where aqueous samples or reagents or combinations of both are dispensed into a microfluidic chip by a hydraulic medium consisting of mineral oil.

FIG. 1B shows another preferred embodiment of the injection reservoir, where the hydraulic fluid is delivered with a syringe pump.

FIG. 2A is a schematic of an embodiment showing aspiration and dispensing in a conical-shaped reservoir of a liquid using an immiscible hydraulic fluid pressurized by a syringe pump. The conical tip is inserted into a receptacle in the microfluidic device and contacts the surrounding device material that is an elastomer to form a fluidic seal. The height of the receptacle is chosen relative to the cone angle and length of cone to ensure there is a gap between the end of the tip and the bottom of the microfluidic channel larger than a gel bead diameter to ensure there is no blockage as gel beads or cells exit the reservoir.

FIG. 2B is a schematic of an embodiment showing aspiration and dispensing in a conical-shaped reservoir of a liquid using a miscible hydraulic fluid pressurized by a syringe pump. The conical tip is inserted into a receptacle in the microfluidic device and contacts the surrounding device material that is an elastomer to form a fluidic seal. The height of the receptacle is chosen relative to the cone angle and length of cone to ensure there is a gap between the end of the tip and the bottom of the microfluidic channel larger than a gel bead diameter to ensure there is no blockage as gel beads or cells exit the reservoir.

FIG. 2C shows a photo of a reservoir with close packed gel particles in a three-dimensional close pack configuration in the reservoir connected to a microfluidic channel where the dimensions of the channel result in a two-dimensional close pack configuration.

FIG. 2D is a schematic showing an example of multiple parallel transfer of cells from wells in a microtiter plate to each cell input port of one or more microfluidic device. This embodiment describes three-dimensional motion of a connected series of hydraulically driven reservoirs for aspirating a given volume of cells from one or more samples residing in one or more wells of a microtiter plate into the reservoir attached to the end of the syringe pump. The reservoir is then moved, positioned over the microfluidic device inlet and the cells are then dispensed into the microfluidic device. The reservoir is then removed, replaced with a new reservoir and the process repeated for another set of microfluidic devices. In this way multiple devices can be used for parallel processing of one or more cells prepared and stored in a microtiter plate.

FIG. 3A is a schematic showing examples of how the flow from different reservoirs in a microfluidic device. In the first example a porous material is inserted in the microfluidic channel to act as a resistive element to impede the flow for a fix pressure difference between the device inlet and outlet. In the second example, a serpentine element is inserted to lengthen the microfluidic channel and increase the fluidic resistance. These two flows are combined at a Y junction and a third fluid is added downstream. Oil is injected and to form microfluidic drops that are collected in a reservoir.

FIG. 3B is a schematic illustrating an example of integrating the reservoir and capillary microfluidic channel in a pipette tip as a single integrated assembly. The tip is then engaged with the microfluidic circuit and either replaces a microfluidic channel or adds an additional microfluidic channel to an existing microfluidic circuit.

FIG. 3C is a schematic illustrating an example whereby particles are loaded into a pipette tip that is inserted into a receptacle in the microfluidic device. A differential pressure is then applied to drive the fluid with particles from the pipette tip into microfluidic device.

FIG. 3D is a schematic illustrating another approach whereby a fluid is loaded in a pipette tip and the pressure or vacuum applied to the pipette tip to either dispense or aspirate the fluid in the pipette tip is controlled by a flow controller integrated into the tubing connecting the pipette tip to a pressure source. The flow is controlled by a clamp or restriction in the tubing that increases or decreases the resistance to flow through the tubing.

FIG. 4A is a schematic illustrating an apparatus to collect droplets. An outlet tube introduces the droplets into a sealed tube containing a droplet compatible liquid.

FIG. 4B is a schematic showing two different orientations of the tube to collect a droplet emulsion in a droplet compatible liquid in the sealed tube.

FIG. 4C is a schematic illustrating how the drops are removed from the tube once collected in the tube. The emulsion is typically less dense than the surrounding liquid, the emulsion floats on top of the liquid and is removed by a pipette.

### DETAILED DESCRIPTION

The present invention is directed to a fluidic interface for delivering a fluid into a microfluidic device, the interface comprising a chamber comprising a first accepting/delivering fluid opening and a second accepting/delivering fluid opening, each opening being positioned opposite to the other, wherein the diameter of the first accepting/delivering fluid opening is smaller than the internal diameter of the chamber and a tubing system connecting the first accepting/delivering fluid opening to a pressure source capable of generating positive or negative pressure. The interface is characterized in that the second accepting/delivering fluid opening is designed to mechanically limit its insertion into a receptacle of a microfluidic device to ensure a predetermined gap (H) between the second accepting/delivering fluid opening and a lower side of the receptacle of a microfluidic device.

As used therein the term “fluidic interface” relates to a device for transporting liquids.

In one embodiment of the invention the chamber and tubing system comprise a first type of fluid, preferably a hydraulic fluid.

Especially preferred said first type of fluid is miscible or immiscible with a second type of fluid to be transported in said chamber.

In an embodiment of the invention, the first type of fluid is miscible with the second type of fluid and said second type of fluid contains a plurality of particles.

In another embodiment of the invention, the first type of fluid is immiscible with the second type of fluid, independently of the presence of particles in said second type of fluid.

Especially preferred is a fluidic interface wherein the interface between said hydraulic fluid and said fluid containing a plurality of particles is characterized by the absence of air.

The invention is further directed to a method for delivering a fluid in a microfluidic device, the method comprising
a. providing at least one fluidic interface,
b. contacting by means of the second accepting/delivering fluid opening a fluid provided in a container,
c. collecting said fluid into the chamber of said fluidic interface by means of a negative pressure applied within said fluid,
d. contacting a receptacle of a microfluidic device to ensure a gap (H) between said second accepting/delivering fluid opening of the chamber and a lower side of said receptacle of a microfluidic device
e. delivering said fluid collected in step (c) into said microfluidic device by means of a negative pressure applied at the end of a microfluidic device.

Preferably the collecting step (c) and the delivering step (e) are characterized by a laminar fluid flow having a Reynolds number value below 10, preferably below 1.

In another aspect, the invention is also directed to a use of the fluidic interface in a method for delivering a fluid into a microfluidic device.

The invention generally comprises a chamber with opposite openings where the first opening is connected to a pressure source capable of creating a pressure differential required for fluid flow and the second opening or exit orifice connected to a pressure source at a lower pressure than the first opening and through which liquid flows to fill the chamber and through which the same liquid is dispensed. The pressure differential may be generated through application of a positive pressure at the first opening via hydraulic or pneumatic pressure, syringe pumps, peristaltic pumps, or other means of creating fluid flow and the second opening is connected to a source at lower pressure which could be atmospheric pressure. One possible embodiment is for the first opening to be connected to atmospheric pressure and the second opening connected to a vacuum. The chamber may be cone shaped with the tube connected to the large opening and the smaller exit opening for immersion in the sample liquid or insertion into a receptacle on a microfluidic device. The tubing and chamber are filled with a hydraulic fluid to facilitate the aspiration and dispensing of fluids from the tubing and chamber. The hydraulic fluid is immiscible relative to the liquids in which it contacts to avoid mixing, dilution and contamination of the liquid by the hydraulic fluid. The condition of immiscibility is critical for dispensing and aspirating homogeneous liquids to ensure the boundary between the two fluids remains well-defined so the hydraulic fluid does not contaminate the liquid during aspiration and dispensing. There are several additional properties specific to selection of the immiscible hydraulic fluid needed to practice the invention. First, the hydraulic fluid should be biocompatible and non-toxic to cells. Second, the hydraulic fluid should be less dense than the second fluid so that it floats on top and does not mix with the second fluid. Third, the hydraulic fluid should not wet the inside surfaces of the chamber and tubing to prevent contamination of the second fluid. Fourth, the hydraulic fluid should have a different refractive index, absorption or both to increase visibility of the interface as an aid to implementing and control the aspiration and dispensing process. One approach to increasing contrast is to include a contrast reagent in the hydraulic fluid. Examples of hydraulic fluid meeting these requirements include mineral oil, silicone oil, soybean oil and other similar liquids. Additives to the mineral oil to increase contrast include a lipophilic dye such as Oil Red O at 0.1-0.5% concentration in the mineral oil. Other lysochrome dyes such as Nile Red, Nile Blue, Sudan III, and Fluorol Yellow may be used among other options.

A second embodiment is in the selection of a hydraulic oil suitable for aspiration and dispensing of a second heterogeneous fluid containing particles such as gel beads or cells. In this case the hydraulic fluidic may be miscible in the fluid carrying the particles; is biocompatible and non-toxic to cells; and, is, in general, inert relative to interaction with particles in the fluid. Examples of miscible hydraulic fluids for cells would be the buffer in which the cells are suspended such as PBS, HEPES, HBSS, and Tris among others. Examples of miscible hydraulic fluids for hydrogel beads could include TET, PBS, TBSET, or 5× First Strand Buffer in which the hydrogel beads are suspended. Different from the case of using an immiscible hydraulic fluid, there is no need to include a contrast agent in the case of miscible hydraulic fluid since there is no boundary interface to visualize.

Laminar fluid flow is important to ensure the boundary interface is not disrupted and there is no mixing across the boundary layer in the case of an immiscible hydraulic fluid or mixing of particles into a miscible hydraulic fluid. Achieving these flow conditions means the Reynolds number of the fluid flowing through the tubing and reservoir is well within the laminar flow regime. The Reynolds number is ideally in the Stokes flow regime (Reynolds number <<1), however Reynolds number <10 can be acceptable and will depend on the specific geometry. It is undesirable to have any mixing, active or passive, between the hydraulic fluid and the second fluid in the reservoirs. Additionally, no complex geometry creating multi-layered flow, split-and-recombine flow, recirculation flow, or other passive micromixers can be used which will increase mixing of the two fluids at the interface. In the case of hydrogel beads, a low Reynolds number flow ensures the hydrogel beads do not mix with the miscible hydraulic fluid and remain dense, closely-packed together during aspiration from their storage tube and dispensing into the microfluidic device. For cells, a similar consideration applies but in this case the low Reynolds number flow minimizes dispersion of cells into the miscible hydraulic fluid. Low Reynolds number flow is readily achieved through a combination of reservoir dimensions and flow rates for the density and viscosity of the liquids dispensed.

The requirement of laminar flow with a Reynolds number <<1 for aspiration of particles from a container and dispensing them into a microfluidic device with a miscible fluid is non-obvious. Stokes-Einstein diffusion times and distances for micron-sized particles suggest there is little to no diffusion of particles into the miscible hydraulic fluid during the time required to aspirate or dispense the particles. One example is in the aspiration and dispensing of hydrogel beads starting with the beads in a close, densely packed colloidal gel. The buffer in which the beads are packed may be the miscible hydraulic fluid for aspiration of beads into the reservoir and dispense beads into a microfluidic device. The Stokes-Einstein diffusion rate of micron sized spherical gel particles at low Reynolds number flow results in negligible diffusion-based mixing over a typical experimental time of one hour. Furthermore, if the orientation of the reservoir is maintained vertically, gravitational sedimentation of the particles will work to maintain a separation between the particulate and the hydraulic fluid. A second example would be cells where the hydraulic fluid may be the buffer in which the cells are suspended and used to aspirate cells into the chamber and dispense the cells into the microfluidic device. A third example would be fluorescent, phosphorescent or metallic particles (like quantum dots or colloidal magnetic particles) used as optical labels for detection of small molecules or sub-diffraction limited particles. The use of a miscible hydraulic fluid in this scenario has the additional benefit of acting as an in-line wash step following labelling of molecules or particles. A fourth example would be the use of a complex fluid, such as blood, serum, or other bodily fluids in an assay. The use of a miscible hydraulic fluid has the benefit of acting as a wash fluid and ensuring the entirety of the sample may be used without loss, simply by flowing until the hydraulic fluid enters the microfluidic device.

In order to keep the either the hydraulic fluid or the dispensing fluid from “wetting” or adhering to the inside of the reservoir, a liquid coating, e.g.Teflon™, can be aspirated into the reservoir and dispensed before the desired fluid is aspirated. This will ensure the non-adhering of higher viscosity material, such as a concentrated gel, to the inside of the reservoir. This coating is not limited to chemical compounds containing anti-wetting properties. Surface modification of the innate material to reduce surface energy and critical surface tension, such as surface passivation, or nanostructured material inducing Cassie-Baxter wetting will reduce overall wetting as well.

The tubing connecting the fluid driving source has an internal diameter minimizing the pressure drop between the source and chamber. This to ensure the pressure range compatibility with available lab pressure sources or that generated by a syringe pump and over a range of hydraulic fluid viscosities. The interface between the tubing and chamber may be a solid plug made from a flexible material like PDMS through which the tubing is inserted to form a hermetic seal that prevents leakage of fluid. Alternatively, the connection can be made with an industry standard Luer taper fluidic connector.

For the connection to the microfluidic device, the device or the interface material may be a compliant elastomer like PDMS. The receptacle into which the exit orifice is inserted connects an interior microfluidic channel to outside the device. The exit orifice outside diameter (OD) of the chamber equals the inside diameter (ID) of the microdevice receptacle so that when the exit orifice is inserted into the receptacle, a fluidic seal is formed around the orifice that prevents fluid leakage. The taper angle of the chamber cone has to be such that as the exit orifice is inserted into the receptacle, the outside surface of the cone engages with the receptacle wall and limits the depth into the microfluidic device which the exit orifice can be inserted. Furthermore, the cone angle, length and diameter of the receptacle and diameter of the exit orifice are selected such that the exit orifice is mechanically limited by contact with the receptacle wall and the exit orifice does not touch the microchannel bottom and block the flow of fluid from the chamber into the microfluidic device. The gap between the exit orifice and the microchannel bottom must be big enough to ensure the flow of cells, hydrogel beads and other particulates without impediment and without imposing a shear force that could damage or break apart the particulates. The exit orifice of chamber may be at least 1.8 larger than the largest particulate (e.g. gel bead or cell) to allow the passage of the particulate without blockage or imposing shear stress on the particles that could possibly fragment the bead. The maximum exit orifice diameter is dictated by the wall thickness of the chamber and the ID of the microdevice receptacle into which the chamber is inserted. Another embodiment is to have a shoulder on the exit orifice to mechanically limit insertion depth or relying on the elastic rebound of the microdevice material to keep the orifice from touching the bottom.

The dead or non-useful volume in the chamber is minimized or eliminated by moving under positive pressure the hydraulic fluid to the exit orifice, inserting the orifice into the second liquid and aspirating the liquid into the chamber. Aspirating liquids with this starting condition prevents entrapment of an air bubble which displaces higher value materials (e.g. cells or reagents) and it efficiently utilizes all the available volume in the chamber for liquid aspiration and dispensing. This is important feature of the invention if the there is a limited amount of sample or reagent available for reaction and/or analysis with a microdevice since there is no volume where cells or hydrogel beads can become entrapped, thus increasing further the overall utility of the invention. Similarly, since there is no dead volume there is also no volume where cells could sediment and be lost for analysis. Finally, the connection and dis-connection of the chamber is performed manually and with a simple and reliable mechanical fluidic interface that renders itself potentially to automated or semi-automated operation.

The use of a single vacuum source at the exit of the microfluidic chip may be used to drive flow from a one or many reservoirs through the chip simultaneously. A key challenge when there is a fixed pressure between the microdevice inlet and outlet is how to set the flow through each microfluidic channel to achieve specific functional goals. There are two general approaches possible—the first based on passive methods to control fluid flow and the second based on active methods to control the fluid flow into different microfluidic channels in the microdevice. These approaches could be implemented either in the microfluidic device itself, in the reservoir connected to the microfluidic device or both. There are several passive methods possible for microfluidic flow control as part of this invention. First, the microchannel dimensions can be decreased in size to increase resistance to fluid flow thereby decreasing the volumetric flow rate. For example, it is well-known via the Hagen-Poiseuille equation for a microfluidic channel with a circular cross-section with radius R and pressure difference ΔP between channel inlet and outlet, the volumetric flow rate Q will scale in proportion to R⁴. This scheme could be implemented in the microfluidic device or it in the reservoir as a narrowing or reduction in cross-section of the exit orifice or the reservoir itself. It could also be implemented as a reservoir with a high length-to-cross-section ratio such as a long, flexible tubing made from a material such as Teflon or polyethylene. The tubing could also have an adjustable restriction such as a means to partially collapse the tubing at a specific point or points along its length that would be used to adjust the volumetric flow of liquid through the tubing. This could also be part of a feedback control system to change the flow from the reservoir under feedback control based on flow through from the reservoir.

In another related embodiment, with this single vacuum source, one or more fluidic reservoirs open to the atmosphere can be connected to the fluidic device at a time, providing the pressure difference to move and the fluids in each reservoir towards an outlet. An alternative is to instead apply a positive pressure to the reservoirs by applying a gasket to positively pressurize all reservoirs simultaneously to push fluid from the reservoir into the microfluidic device. If multiple reservoirs are to be connected, the fluid can be transferred into the reservoirs using, for example, a multichannel pipette or similar tool.

A related embodiment is to control the gap H between the exit orifice of the receptacle and bottom of the microfluidic channel. Similar to the previous example of flow through a tube, the volumetric flow rate Q through the gap region will vary as H³ so decreasing the gap decreases the fluid flow rate. The gap could be either fixed in position based on the receptacle interface geometry or it could be part of a feedback control loop to control the fluid flow through the interface with the reservoir moved relative to a fixed microfluidic channel or the channel fixed and the elastomeric material comprising the microdevice moved to partially block the channel and change H.

Another approach to decreasing volumetric fluid flow in the microfluidic device is to insert a serpentine channel whereby the volumetric flow rate is decreased for a fixed pressure difference from the viscous drag on the fluid from the increased distance it travels through the serpentine structure. Another similar approach is to introduce a resistive fluidic element in one or more channels of the microfluidic device, in the reservoir, in the receptacle interfaced with the reservoir, the exit orifice or in the reservoir. An example of a fluidic resistive element would be a porous glass, polymer or ceramic plug with torturous fluidic pathways that impede the flow of liquid through the microfluidic channel or reservoir. The plug could be synthesized in situ such as a polymer like a hydrogel such as a polyacrylamide or an alginate that is polymerized in the reservoir or in the microfluidic channel and the degree of porosity is controlled and determined by the degree of polymerization.

Another embodiment of a single vacuum source to drive flow would be to actively control the flow from each fluid independently, either manually or with automatic feedback control. This can be done by actively changing the fluidic resistance of channels independently, either off chip through a regulator, or air constriction, attached to each reservoir, or on chip through the control of channel dimensions or fluid viscosity. Channel dimensions, and therefore fluidic resistance, can be controlled on chip by mechanically altering the height of a channel in an elastomeric material, such as PDMS, by applying a mechanical force to the outside of the chip. Channel dimensions can also be controlled by the incorporation of piezoelectric materials in the chip itself. Reducing the channel height is an effective means of controlling flow rate since there is a non-linear dependence of flow rate on channel height.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the invention includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

### EXAMPLE 1

The first example consists of a pressure-driven system that allow a fine and fast adjustment of the flow-rates (i.e.: MFCS from Fluigent). The injection reservoir for delivering aqueous liquids is connected to a flow rate sensor and a valve which allows switching between a positive or negative pressure controlled hydraulic fluid reservoir.

A feedback loop system consisting of a flow sensor, a pressure regulator and the computer-based control algorithm allow precisely tuning of flow rates and fast response times in the millisecond range.

By using the valve to switch between positive and negative pressure and their corresponding hydraulic fluid reservoirs, aqueous solutions can be aspirated or dispensed in a controlled fashion by either flow rate or volume or a combination of the two.

The advantage of a pressure driven injection system consists in a minimized dead volume by connecting the reservoir in close proximity to the microfluidic channels through which reagents or solutions are delivered. Secondly, the pressure system allows for faster response times and real-time control with the feedback control of flow rates enabling monodisperse droplet productions over time periods beyond 1 hr.

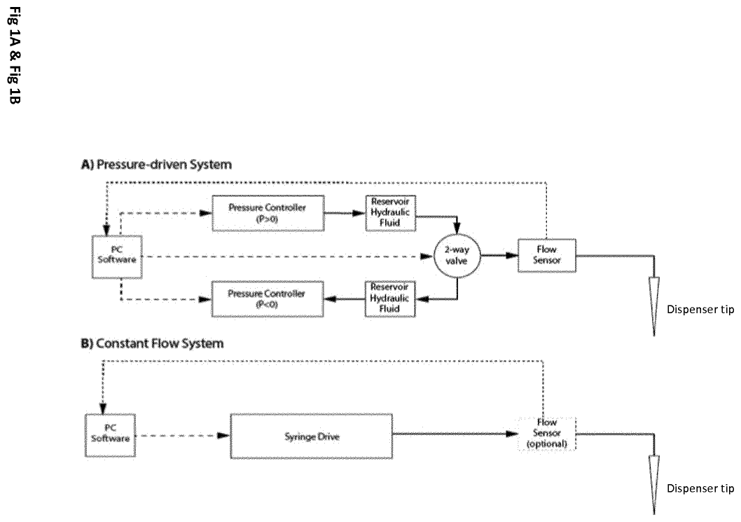

FIG. 1A shows one preferred embodiment of the injection reservoir, where aqueous samples or reagents or combinations of both are dispensed into a microfluidic chip by a hydraulic medium consisting of mineral oil. The pressure is applied in a reservoir containing mineral oil and the resulting flow-rates are monitored by the flow sensor. This flow-controlled mineral oil solution is used to drive aqueous solutions in the injection reservoir.

The injection reservoir consists of a pipette tip (usually 200 μL Low Retention Pipet Tips (TipOne, Starlab Group)), a PDMS plug with a hole and connecting tubing. The connection to the chip is made by inserting softly the conical point of the tip into the chip inlet (holes were punched with the appropriate size of a biopsy puncher ranging from 0.5 to 1 mm diameter depending on the tip size).

FIG. 1B shows another preferred embodiment of the injection reservoir, where the hydraulic fluid is delivered with a syringe pump. As most syringe pumps in combination with glass syringes achieve a high degree of accuracy in set flow rate and actual flow rate, a flow sensor might be implemented as an optional feature to feedback to the computer controlling the pumps.

### EXAMPLE 2

This example illustrates application of the invention in the context of transferring reagents, barcoded hydrogel beads and cells into a microfluidic device for co-encapsulation of polyacrylamide hydrogel beads and cells into microdroplets. A syringe pump applies a stroke motion to a syringe plunger (i.e.: KDS 910 Legacy OEM syringe pump, neMESYS pumps from Cetoni or PHD2000 from Harvard Apparatus) to drive fluids through the microfluidic device. It is a flow-regulated system that allows a wide range of flows by using a set of syringes with different inner diameters.

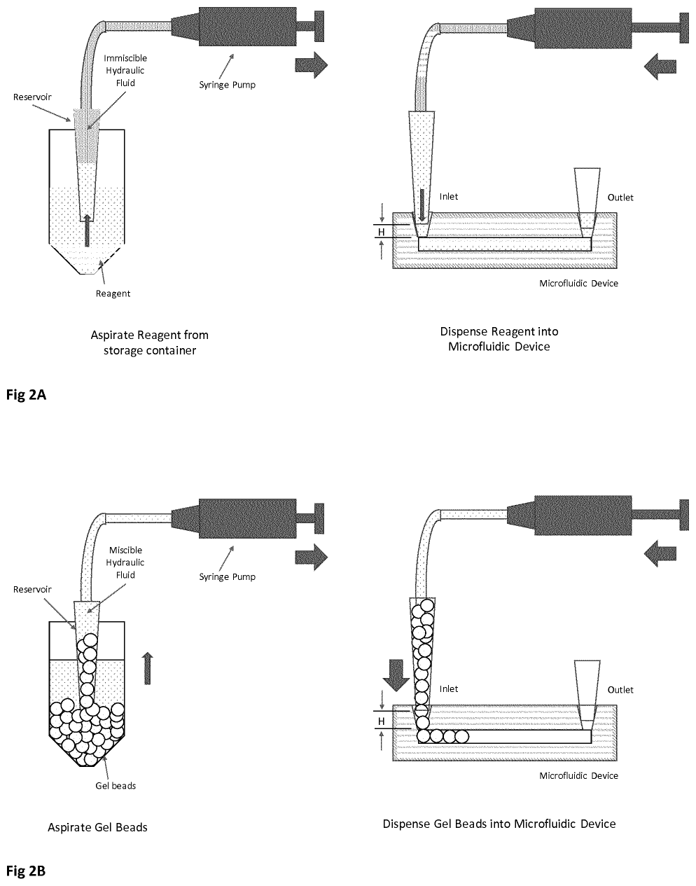

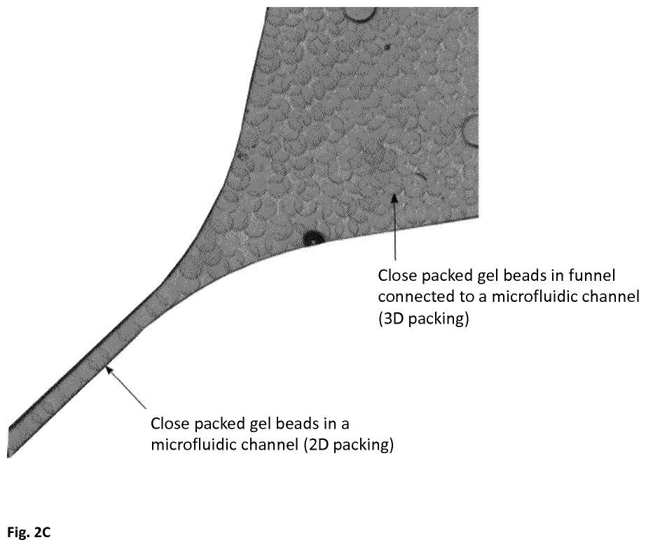

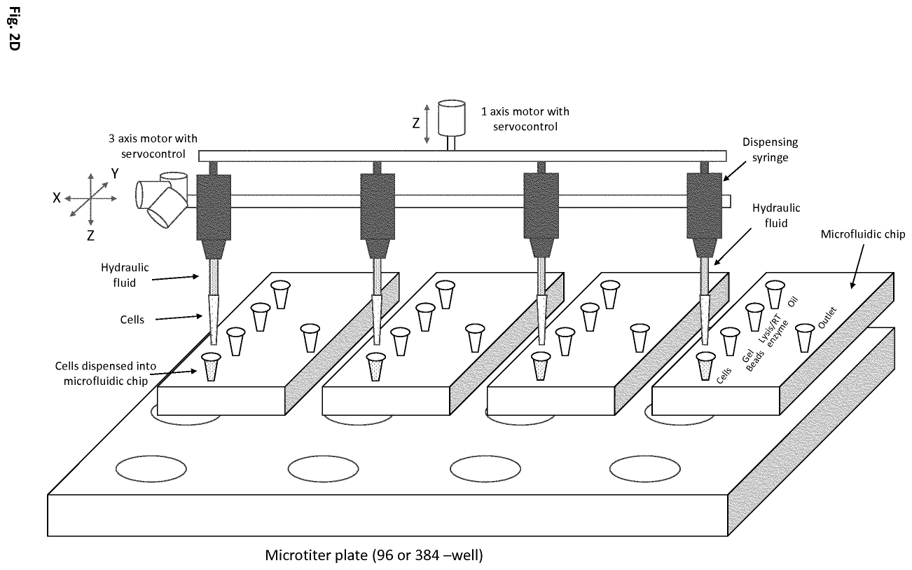

In this application four independent syringe pumps are used to drive four different fluids into the microfluidic chip. The first pump is set up with a syringe, tubing, and conical tip for dispensing the hydrogel particles. This syringe utilizes a miscible fluid containing Tris, EDTA, and Tween 20. The second pump is set up with a syringe, tubing, and conical tip entirely filled with HFE7500 with 2% (w/w) fluorosurfactant from Ran Biotechnologies. The third and fourth syringe pumps are set up with syringe, tubing, and threaded Luer taper connector for connection with a Luer compatible conical reservoir. These syringes are filled with immiscible mineral oil dyed with Oil Red-O dye and these pumps are used for withdrawing and dispensing a cell suspension and a mixture of reverse transcription reagents as well as cell lysis buffer (FIG. 2A). The Luer compatible conical reservoirs disposable to minimize cross contamination

Once each syringe is mounted on the appropriate pump, the first and second pump can dispense fluid rapidly until the fluid reaches and slightly protrudes from the tip of the reservoir. To ensure no air bubbles are entrapped, the excess fluid is wiped away so that only the fluid contacts the sample fluid, gel beads or cells in solution to be aspirated. For the third and fourth pump, the luer compatible conical reservoirs can be connected to the tubing, held vertically so the exit is at the top, then the syringe pump can dispense fluid, thereby filling the reservoir. When the reservoir is filled, it can be inverted and stored without the loss of the hydraulic fluid due to surface tension. Once all four syringe pumps are connected to the appropriate tubing and reservoirs, the solutions and experiment can be prepared.

Prior to loading of gel particles and cells into the reservoirs the cell suspension is prepared to have few or no cell doublets or clumps and is free of cell lysate. The gel beads are prepared by washing in low ionic strength buffer with minimal EDTA such as Tris, Tween 20, to swell the hydrogel beads and remove any oligo barcode that may have spontaneously cleaved from the hydrogel bead and is now in solution. The gel beads are next washed in Igepal, and 5x First Strand Buffer to shrink the beads to their original size, centrifuged and the supernatant removed to ensure a colloidal gel pellet is formed. A concentrated pellet of gel particles is needed to ensure dense, close packing of gel particles during aspiration of gel particles into the conical tip reservoir and injection into the microfluidic device (FIG. 2C). The hydraulic fluid of 5× First Strand Buffer is first aspirated into the conical tip, connecting tubing and syringe. This fluid is then dispensed to remove any air bubbles and ensure only fluid contacts the gel particle pellet. The prepared gel particles are then aspirated into the conical tip and to do this, the conical tip is inserted into the bottom of the gel particle pellet and the syringe pump withdraws at 500 μL/hr until the desired volume of gel beads is loaded into the conical tip and tubing (FIG. 2B). To ensure the proper final concentration in the droplets, the reverse transcription enzyme and lysis buffer mixture are prepared at a higher starting concentration, typically 30 μL of RT/Lysis Mix per 1000 cells with an additional 40 μL for priming. For example, if the plan is to encapsulate and barcode 10,000 cells, 340 μL of RT/lysis mix is prepared. The RT/lysis mix is kept cold and made by mixing 1.3× RT premix with MgCl2, DTT, RNaseOUT, and SuperScript III. The RT Lysis mixture can then be transferred to the luer compatible conical reservoir by inserting the exit of the conical reservoir into the bottom of the tube containing the RT/lysis mix and withdrawing the appropriate volume at a flow rate of 2000 μL/hr. For the cell preparation, the cell concentration is adjusted to be 100,000 cells/mL or less, in 1× PBS. Eighteen (18) μL of density-matching agent, such as OptiPrep, is added for every 100 μL of cell suspension to ensure the cells are neutrally buoyant and don't sediment during aspiration and dispensing. It is important the cells are kept cool (4C) during the preparation immediately prior to aspirating and dispensing them into the microdevice to ensure cell viability. Once the cell suspension is prepared it can be loaded into the conical reservoir connected to syringe pump 4 by inserting the exit of the conical reservoir into the bottom of the tube containing the cell suspension and withdrawing at a low flow rate (2000 μL/hr) so as to not apply excessive shear stress to the cells.

Once all inputs are loaded in the tubing or luer compatible conical reservoirs, a collection tubing of known length and volume is connected to the outlet channel. The tubing and conical reservoirs are primed to ensure there are no air bubbles, and liquids are completely filling the tube. Once the tubing and reservoirs are fully primed, they may be interfaced with the encapsulation chip and the chip itself can be primed. Generally, the conical tips for cells is inserted first by pushing the luer compatible conical reservoir until it touches the bottom of the cell input. The elastic properties of the PDMS chip and dimensions of the microfluidic channel ensures there is a gap between the exit of the reservoir and the bottom of the chip that does not block fluid flow. Next the RT/lysis mix can be connected in the same manner, followed by the beads, and finally the droplet oil.

The microfluidic device is primed by running each of the syringe pumps in sequence at 100 μL/hr, 200 μL/hr, 200 μL/hr, and 200 μL/hr respectively. Once the beads are fully packed as shown in FIG. 2B. The syringe pump flow rates must be adjusted to incorporate the correct volume of cell phase, and RT/Lysis mixture as well as containing only a single bead. It is necessary to obtain a high fraction (<80%) of droplets containing a single gel particle in order to efficiently bar code cells. A low encapsulation rate of gel particles results in wasted cell sample, which may be very limited.

Once high occupancy of single gel particles in droplets is achieved, the emulsion coming from the collection tube should be placed in a 1.5 mL Eppendorf tube containing 200 μL of mineral oil and placed in a cooled collection block. The mineral oil is necessary to prevent evaporation and droplet coalescence. It is also important to monitor the devices operation and adjust flow rates during collection if necessary. There should be at most 1 gel particle in each droplet and about 90% of all droplets should contain beads. Gel particle occupancy can be determined from short movies recorded at the outlet of the microfluidic device or by simply monitoring the droplet flow. Ensure that the cell encapsulation rate remains constant by monitoring the cell inlet with the droplet size between 3.0-3.5 nL. After the desired number of cells is encapsulated, unplug the tubing from the outlet, stop the pumps, and let the emulsion in the tubing drain into the collection tube by gravity. For the first syringe pump, the gel particles remaining in the tubing and tip can be dispensed into a separate tube and recollected simply by pushing the miscible hydraulic fluid out as well as the beads. This ensure no beads remain in the tubing and no beads are wasted. For the third and fourth syringe pump dispense the remaining fluid from the luer compatible conical reservoirs into a waste container. Dispense a small amount of the immiscible hydraulic fluid to ensure no contaminants remain at the interface. Invert the tips so the exit is above the tubing and withdraw the hydraulic fluid back into the syringe for re-use. When the luer compatible conical reservoirs are empty they can be removed, disposed of, and replaced.

Another related embodiment is to further automate the movement of the conical tip reservoirs so that more than one microfluidic device can be loaded with cells in parallel. The benefit of this approach is to increase the processing throughput so that cells from multiple samples can be barcoded in parallel for sequencing. FIG. 2D is a schematic showing an example of a device for multiple parallel transfer of cells from wells in a microtiter plate to each cell input port of one or more microfluidic device. A three-dimensional motion system under feedback control positions a mechanically connected one or two-dimensional array of hydraulically driven reservoirs with conical tips over one or more wells of a microtiter plate positioned adjacent to an array of microfluidic devices positioned such that the cell input ports are spaced at a distance equal to the wells of a 96 or 384-well microplate. The reservoirs are driven by syringe pumps connected to a common servocontrolled motor. The reservoir tips are positioned above one or more wells in a microtiter plate, they are moved to be in contact with the fluid containing the cells, the hydraulic motor is actuated and a specified volume of cells in suspension are aspirated into the reservoir. The reservoirs are then moved and positioned over one or more cell input ports for one or more microfluidic devices, the reservoirs are lowered such that the conical tips are positioned such that dispensing of cells and fluid from the conical tip reservoir allows the cells and fluid to enter into the cell microfluidic channel. The tip is then withdrawn, replaced with a new reservoir and the process repeated for another set of microfluidic devices. In this way multiple devices can be used for parallel processing of one or more cells prepared and stored in a microtiter plate. In another related embodiment is the use of a multichannel pipette dispenser, to transfer fluids in the reservoirs to the chip. For example, using a multichannel pipette, the fluids or particles of interest can be aspirated by hand and interfaced with the microfluidic device. The reservoirs are then ejected from the transferring tool and the reservoirs pressurized via a gasket seal to move fluids from the reservoir to the device.

### EXAMPLE 3

A third example consists of the use of a single vacuum source at the exit of the microfluidic chip which is used to drive flow from a one or many reservoirs through the chip simultaneously. In the simplest case, the flow rate of each fluid entering the chip may be determined passively by designing the fluidic channels to have a specific fluidic resistance, thereby determining the flow rate of that fluid. According to Hagen-Poiseuille, the pressure differential applied to a circular tube in laminar flow is directly proportional to the flow rate and the fluidic resistance.

$$Δ P = \frac{8 μ L Q}{π {R}^{4}}$$

Where ΔP is the pressure differential, μ is the fluid dynamic viscosity, L is the length of the channel, Q is the volumetric flow rate, and R is the radius of the channel. The fluidic resistance is therefore proportional to:

$$R = \frac{8 μ L}{π {R}^{4}}$$

A unique solution for planar Poiseuille flow can be used to define the resistance in a rectangular cross section channel as:

$$R = \frac{12 μ L}{{WH}^{3}}$$

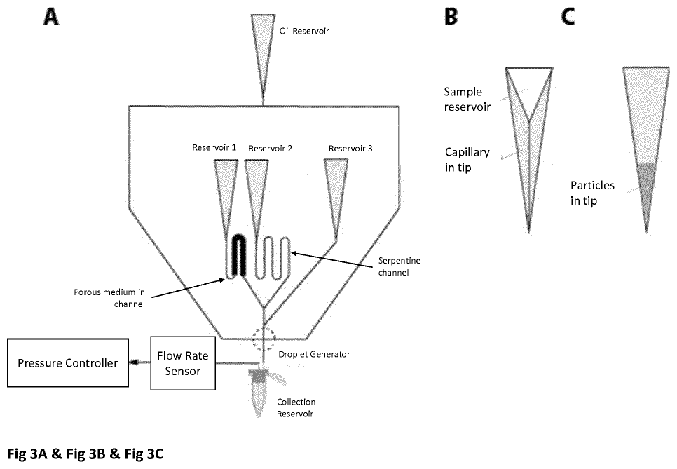

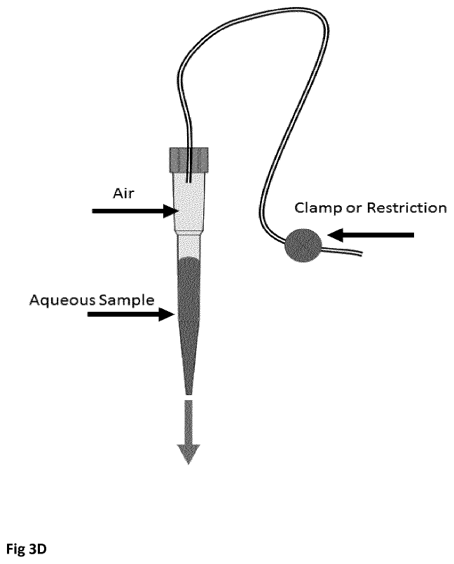

This would provide the simplest form of flow, but offer no active control of fluid flow. In this scenario each channel has its own fluidic resistor, which can be controlled by lengthening or narrowing the channel. Based on the applied negative pressure at the outlet all channels will experience the same pressure differential. Therefore, the flow will be controlled by the fluid viscosity, which can be known or varied with the addition of a viscous liquid such as glycerol or by changing the temperature of the fluid, and the channel width and height. By adding the correct length of serpentine resistors the fluidic resistance can be precisely determined in advance for each fluid (FIG. 3A).

Another embodiment is to include flow resistive elements in the reservoirs themselves to control the flow of fluid exiting the reservoir and entering the microfluidic device. One example of a flow resistive element would be a smaller internal diameter of the exit orifice or a length of the reservoir. This would decrease the flow rate for a fixed pressure difference between the reservoir inlet and the microfluidic device outlet (FIG. 3B). Another example is insertion of a flow resistive element into the reservoir such as a close-packed filter of micron sized particles typically used in chromatography applications. The tortuous path through the filter is an impedance to fluid flow and therefore would be another approach to modifying the reservoir to change the rate of fluids exiting different reservoirs connected to different inlets of the microfluidic device (FIG. 3C).

Another embodiment using a single negative pressure source to drive flow is to actively control the flow from each fluid independently. This can be done either manually or with automatic feedback control. This is achieved by actively changing the fluidic resistance of channels independently from one another. Off chip this can be accomplished through a regulator, or air constriction, attached to each reservoir, or through modification of the fluidic interface, such as a conical reservoir. One method of controlling the fluidic resistance via the fluidic interface is to apply a downward force on the conical reservoir, thereby reducing the gap at the exit of the reservoir. By reducing the gap of the reservoir exit, you can effectively control the resistance of each channel independently. Although cylindrical coordinates would more accurately describe the resistance with respect to the height of the gap, the resistance would indeed increase with the height cubed. This offers a very effective method of controlling the resistance of each channel without the need to manipulate or otherwise modify the chip in anyway. This makes this method of controlling resistance more broadly applicable. Another method of controlling the resistance for each channel via the fluidic interface is to modify the resistance of the air entering the fluidic reservoir. By applying a restriction to the reservoir itself or a tube connected to the reservoir as in FIG. 3D, the resistance of fluid exiting the reservoir can be controlled. This method would impact the channels fluidic resistance by increasing the resistance the air sees when entering the reservoir. This has the benefit of the working fluid being air, which has a much lower viscosity, thereby giving much greater sensitivity in changing the resistance.

Modifying the fluidic resistance can be achieved on chip through the control of channel dimensions or fluid viscosity. Channel dimensions, and therefore fluidic resistance, can be controlled on chip by mechanically altering the height of a channel. In an elastomeric material, such as PDMS, the height can be altered by applying a mechanical force to the outside of the chip. By applying this mechanical force, the channel is compressed drastically increasing the resistance. The channel dimensions can also be controlled by the incorporation of piezoelectric materials in the chip itself by applying a voltage to the piezoelectric material the channel can be compressed offering precise electric control of the fluidic resistance. Reducing the channel height is an effective means of controlling flow rate since there is a cubic dependence of flow rate on channel height.

EXAMPLE 4

A fourth example consists of a detachable collection reservoir for emulsions. After producing emulsions, storage in an appropriate reservoir for further processing, for example in PCR machines or thermoblocks. In the simplest design, a standard 1.5 ml Eppendorf tube (DNA LoBind or Protein LoBind) or even a PCR tube can be used, but a PDMS plug is inserted and hold in place by an interference fit to prevent leakage of liquids and ensure visibility to the sample.

The depth of which the PDMS plug can be inserted into the tube is limited by stop cap integrated into the plug which allows users as well to remove the plug again. The PDMS plug has two holes, one in the center and one at the edge, with a diameter suitable for connecting tubing, typically 0.75 mm in diameter.

The PTFE tubing which is plugged in the center reaches the bottom and can be used as inlet. The second PTFE tubing is plugged in flush with the PDMS plug to ensure that the emulsion can be pumped out completely without being trapped in the collection reservoir.

The collection reservoir is pre-filled with the appropriate oil, for most applications either pure HFE-7500 or HFE-7500 containing 0.1% (w/w) surfactant before it is used.

The advantages of such a detachable collection reservoir are process related. First, due to the detachable nature of the collection reservoir, multiple emulsions can be collected in a single tube. Second, the arrangement of the inlets and outlets allow multiple user modi, for example collection of emulsion, intermediate storage for reinjection of emulsions in subsequent process steps into a microfluidic droplet sorting chip. Third, the removable PDMS plug allows to access the emulsion with laboratory pipettes and increase the flexibility to process droplets by other means.

Fourth, the 1.5 ml Eppendorf tube design allows using standard laboratory equipment like PCR machines, thermoblocks and centrifuges which facilitates the use for non-expert users.

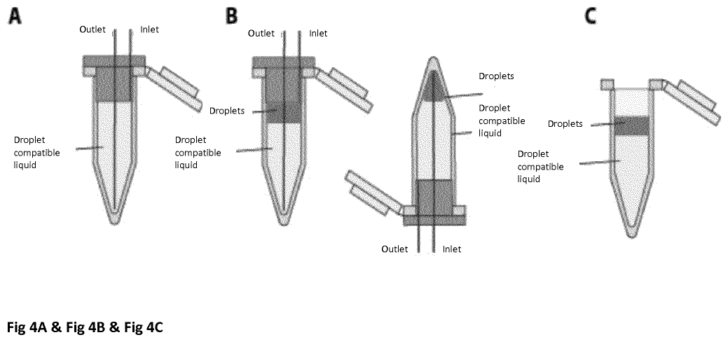

One preferred embodiment of the collection reservoir is depicted in FIG. 4A. The Eppendorf tube has a PDMS cap with the tubing inserted for inlet and outlet. As aqueous emulsions are typically lighter than HFE-7500, a fluorinated oil, the emulsion will be found above the oil phase and clearly visible. HFE-7500 can be used to pump out the emulsion of the collection reservoir or the PDMS cap can be easily and manually removed and a pipette used to aspirate the aqueous emulsion.

Another embodiment is shown in FIG. 4B where the orientation of the collection reservoir can be altered based on the application. For instance, when small numbers of drops are to be collected (for example but not limited to <100,000), the tapered end of the Eppendorf tube is oriented upward so that the buoyant drops are collected and concentrated into the narrowed of the tube. In the instance where the number of drops to be collected is larger (for example but not limited to >100,000) then the tube is oriented with the tapered end downward and the buoyant drops collected at the top of the tube and there is less of a need to concentrate the drops into a smaller volume given the large number.

Another embodiment is shown in FIG. 4C where the orientation of the collection reservoir is facing in gravitational direction when the plug is removed to ensure liquid remains inside the Eppendorf tube to perform further standard pipette operations on the content.

1. A fluidic interface for delivering a fluid into a microfluidic device, the interface comprising:
a chamber comprising a first accepting/delivering fluid opening and a second accepting/delivering fluid opening, each opening being positioned opposite to the other, wherein the diameter of the first accepting/delivering fluid opening is smaller than the internal diameter of the chamber, and
a tubing system connecting the first accepting/delivering fluid opening to a pressure source capable of generating positive or negative pressure,
the interface being characterized in that the second accepting/delivering fluid opening is designed to mechanically limit its insertion into a receptacle of a microfluidic device to ensure a predetermined gap (H) between the second accepting/delivering fluid opening and a lower side of the receptacle of a microfluidic device.

2. The fluidic interface according to the claim 1, wherein said chamber and tubing system comprise a first type of fluid.

3. The fluidic interface according to the claim 2, wherein said first type of fluid is a hydraulic fluid.

4. The fluidic interface according to claim 1, wherein said first type of fluid is miscible or immiscible with a second type of fluid to be transported in said chamber.

5. The fluidic interface according to claim 4, wherein the first type of fluid is miscible with the second type of fluid and said second type of fluid contains a plurality of particles.

6. The fluidic interface according to claim 4, wherein the first type of fluid is immiscible with the second type of fluid, independently of the presence of particles in said second type of fluid.

7. The fluidic interface according to claim 1, wherein the connection and/or the interface between said hydraulic fluid and said fluid containing a plurality of particles is characterized by the absence of air.

8. The fluidic interface according to claim 1, wherein the opening of said first accepting/delivering fluid opening is connected to ambient pressure when inserted into a receptacle of a microfluidic device and said second accepting/delivering fluid opening is connected to a negative pressure.

9. The fluidic interface according to claim 1, wherein said chamber is conically shaped along its longitudinal axis.

10. The fluidic interface according to claim 1, wherein the second accepting/delivering fluid opening is at least 1.8 larger than the largest particle.

11. The fluidic interface according to claim 1, wherein the predetermined gap (H) is selected to ensure a flow of particles in absence of a shearing force.

12. A method for delivering a fluid in a microfluidic device, the method comprising:
a) providing at least one fluidic interface according to claim 1,
b) contacting by means of the second accepting/delivering fluid opening a fluid provided in a container,
c) collecting said fluid into the chamber of said fluidic interface by means of a negative pressure applied within said fluid,
d) contacting a receptacle of a microfluidic device to ensure a gap (H) between said second accepting/delivering fluid opening of the chamber and a lower side of said receptacle of a microfluidic device, and
e) delivering said fluid collected in step (c) into said microfluidic device by means of a negative pressure applied at the end of a microfluidic device.

13. The method for delivering a fluid in a microfluidic device according to claim 12, wherein the collecting step (c) and the delivering step (e) are characterized by a laminar fluid flow having a Reynolds number value below 10.

14. (canceled)

15. The method for delivering a fluid in a microfluidic device according to claim 12, wherein the collecting step (c) and the delivering step (e) are characterized by a laminar fluid flow having a Reynolds number value below 1.
